(19) United States
(12) Patent Application Publication
(10) Pub. No.: US 2013/0008882 A1
(43) Pub. Date: Jan. 10, 2013

(54) MOUSE WARMER

(76) Inventors: Yu-Hsiang Hu, New Taipe City (TW); Chih-Cheng Chen, New Taipe City (TW)

(21) Appl. No.: 13/177,544

(22) Filed: Jul. 6, 2011

(51) Int. Cl. H05B 1/00

(52) U.S. Cl. 219/209

(57) ABSTRACT

A mouse warmer includes a mouse electrically connectable to a computer for cursor control and having a housing configured for the grasping of a hand of a user, and an electrical heater mounted in the housing for generating heat to warm the user's hand holding the housing.

### BACKGROUND OF THE INVENTION

1. Field of the Invention

The present invention relates to a mouse design and more particularly, to a mouse warmer, which warms the user's hand that operates the mouse.

2. Description of the Related Art

When using a computer, people usually use a mouse for cursor control. When compared to other input control devices, a mouse is more convenient for operation control.

When using a mouse, the user must hold the housing of the mouse with the hand. When operating the mouse of a computer in winter, the hand is exposed to the cold air and will become stiff and uncomfortable soon. Thus, when using a mouse to perform a drawing work on the screen of a computer or when operating the mouse of a computer under a cold weather condition for a long period, the hand may suffer from chilling injury.

### SUMMARY OF THE INVENTION

The present invention has been accomplished under the circumstances in view. It is one object of the present invention to provide a mouse warmer, which warms the user's hand that operates the mouse. It is another object of the present invention to provide a mouse warmer, which can be carried by a person conveniently for use as a body warmer.

To achieve these and other objects of the present invention, a mouse warmer includes a mouse electrically connectable to a computer for cursor control and having a housing configured for the grasping of a hand of a user, and an electrical heater mounted in the housing for generating heat to warm the user's hand holding the housing.

In one embodiment of the present invention, the electrical heater is detachably attached to the housing corresponding to the area to be grasped by a hand of a user.

In one embodiment of the present invention, the housing comprises at least one fastening member located on the top side thereof corresponding to the area to be grasped by a hand of a user, and the electrical heater comprises a body shell, at least one fastening member located on the bottom side there and detachably connectable to the at least one fastening member of the housing, and a sheet-like electrical heating element arranged at the top side of the body shell.

Further, the mouse comprises a plurality of metal spring plates arranged at the housing and electrically connected to a power circuit thereof. Further, the electrical heater further comprises a control circuit board mounted inside the body shell and electrically connected with the sheet-like electrical heating element for controlling the operation of the sheet-like electrical heating element, a rechargeable battery cell arranged at the control circuit board and chargeable by a charging circuit of the control circuit board, a plurality of electric contacts located on the bottom wall of the body shell and electrically connected to the control circuit board for electrically contacting the metal spring plates at the housing of the mouse for enabling the rechargeable battery cell to be electrically charged by the charging circuit of the control circuit board with the power supply of the mouse.

Further, the mouse comprises an electrical jack located on the front side of the housing, and a USB cable electrically and detachably connected to the electrical jack for electrically and selectively connecting the mouse to a USB port of a computer or an AC power adapter.

Further, the body shell of the electrical heater admits light. The electrical heater further comprises an indicator light installed in the control circuit board and controllable by the control circuit board to emit light through the body shell when the rechargeable battery cell is fully charged during a charging operation, a charge control switch for controlling the charging circuit to charge the rechargeable battery cell, and a temperature control switch arranged at the body shell for controlling the heating temperature of the sheet-like electrical heating element.

The electrical heater of the mouse warmer of the present invention can be detached from the mouse for use of a personal body warmer. For example, when going outside in a cold day, the user can carry the electrical heater to warm the body.

### BRIEF DESCRIPTION OF THE DRAWING

FIG. 1 is an exploded view of a mouse warmer in accordance with a first embodiment of the present invention.

FIG. 2 is an elevational view of the mouse warmer in accordance with the first embodiment of the present invention.

FIG. 3 is a sectional view of the mouse warmer in accordance with the first embodiment of the present invention.

FIG. 4 is an elevational view of a mouse warmer in accordance with a second embodiment of the present invention.

FIG. 5 is a sectional view of the mouse warmer in accordance with the second embodiment of the present invention.

### DETAILED DESCRIPTION OF THE PREFERRED EMBODIMENT

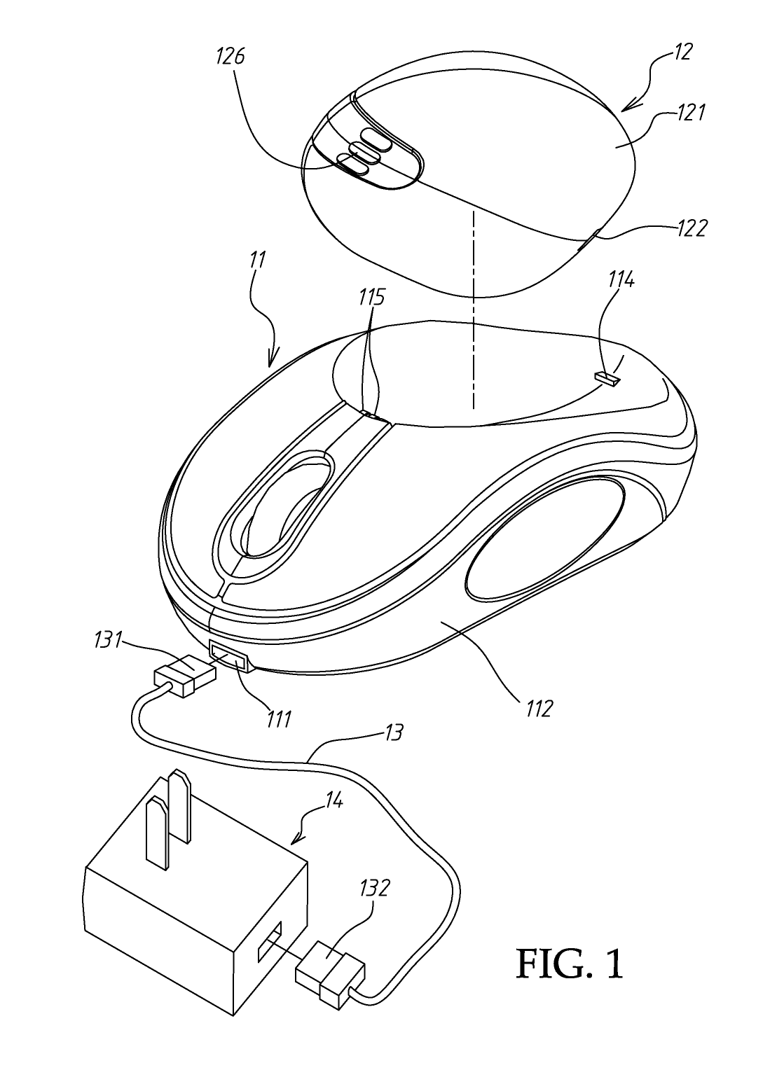

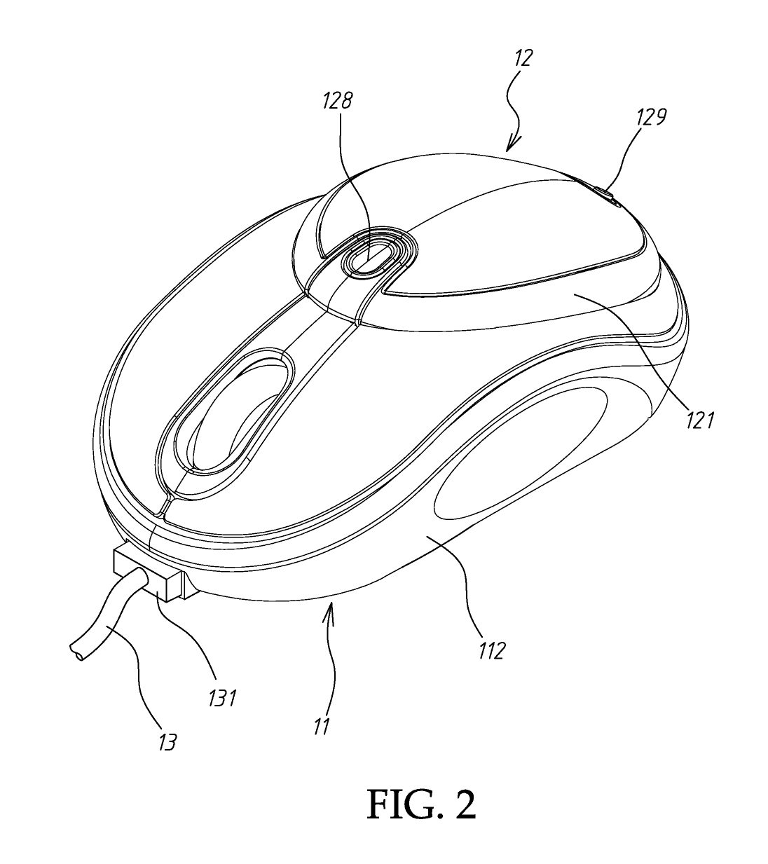

Referring to FIGS. 1-3, a mouse warmer in accordance with a first embodiment of the present invention is shown comprising a mouse 11 and an electrical heater 12. The electrical heater 12 is detachably attached to the mouse 11.

The mouse 11 comprises an electrical jack 111 located on the front side of the housing 112 thereof for the connection of a USB cable 13. The USB cable 13 has a first electrical connector 131 located on its one end and electrically connectable to the electrical jack 111, and a second electrical connector, for example, USB connector 132 electrically connectable to a USB port of a computer (not shown) for signal transmission and power fetching, or an AC power adapter 14 for fetching city power supply. When connecting the USB connector 132 to a computer, the mouse 11 is electrically connected to the computer by the USB cable 13 for cursor control. The housing 112 of the mouse 11 is configured for comfortable hand grasping. The mouse 11 further comprises a circuit board mounted inside the housing 112 and carrying requisite optical components and buttons (not shown) for computer cursor control.

The electrical heater 12 comprises a body shell 121 detachably attached to the housing 112 of the mouse 1. Preferably, the housing 112 has a part of the top wall thereof smoothly inwardly curved for accommodating the body shell 121 of the electrical heater 12. Further, the body shell 121 has a female retaining member, for example, a retaining notch 122 located on the border area of the bottom wall thereof for engagement with a male retaining member, for example, a retaining rod 114 at the housing 112 to keep the body shell 121 in position.

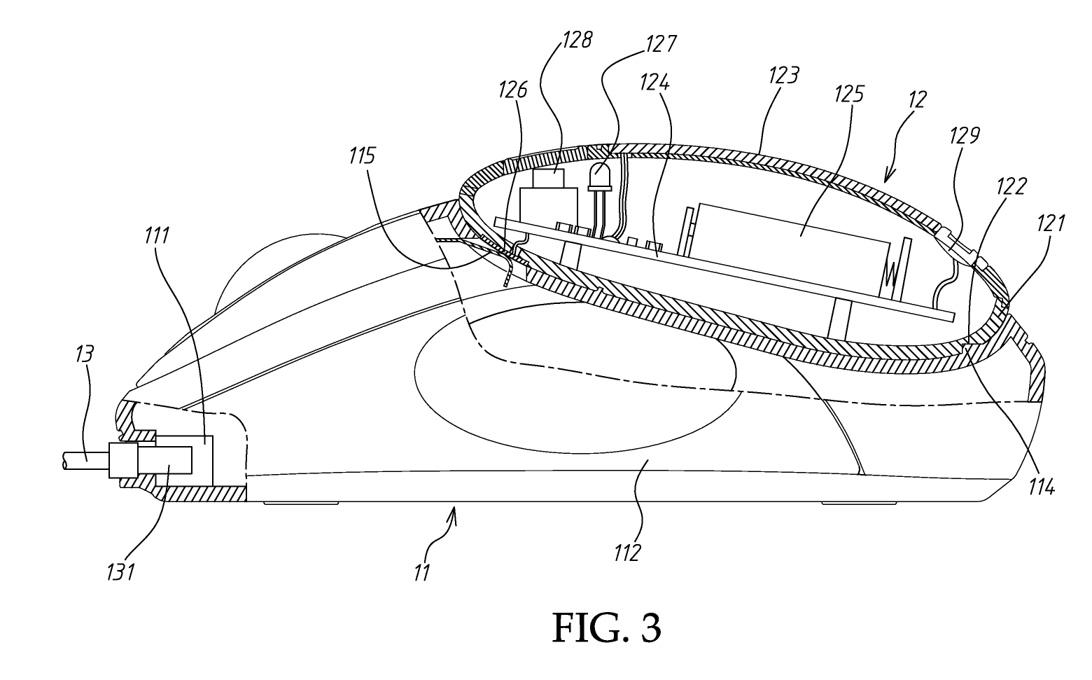

The electrical heater 12 further comprises a sheet-like electrical heating element 123 arranged at the top side of the body shell 121, as shown in FIG. 3, a control circuit board 124 mounted inside the body shell 121, a rechargeable battery cell 125 arranged at the control circuit board 124 inside the body shell 121, a plurality of electric contacts 126 located on the bottom wall of the body shell 121 and electrically connected to the control circuit board 124 for electrically contacting respective metal spring plates 115 that are electrically connected to the power circuit of the housing 11 and arranged at the housing 112 for enabling the rechargeable battery cell 125 to be electrically charged by a charging circuit (not shown) of the control circuit board 124 with the power supply of the mouse 11.

The electrical heater 12 further comprises an indicator light 127, for example, LED light, electrically connected to the control circuit board 124. Further, the body shell 121 admits light. When the rechargeable battery cell 125 is fully charged, the indicator light 127 is turned on to emit light through the body shell 121. The electrical heater 12 further comprises a charge control switch 128 arranged at the top side of the body shell 121 at a selected location, preferably adjacent to the indicator light 127, and operable to control charging of the rechargeable battery cell 125, for example, operable to switch off the charging circuit of the control circuit board 124 when the indicator light 127 is turned on. The electrical heater 12 further comprises a temperature control switch 129 arranged at the top side of the body shell 121 for controlling the temperature of the sheet-like electrical heating element 123, for example, 25° C., 45° C. and OFF.

The electrical heater 12 of the mouse warmer of the present invention can be detached from the mouse 11 for use of a personal body warmer. For example, when going outside in a cold day, the user can carry the electrical heater 12 to warm the body.

As the USB connector 132 of the USB cable 13 of the mouse 11 can be selectively connected to a USB port of a computer for signal transmission and for fetching power supply to charge the rechargeable battery cell 125, or an AC power adapter 14 to obtain city power supply for charging the rechargeable battery cell 125, charging of the rechargeable battery cell 125 is convenient.

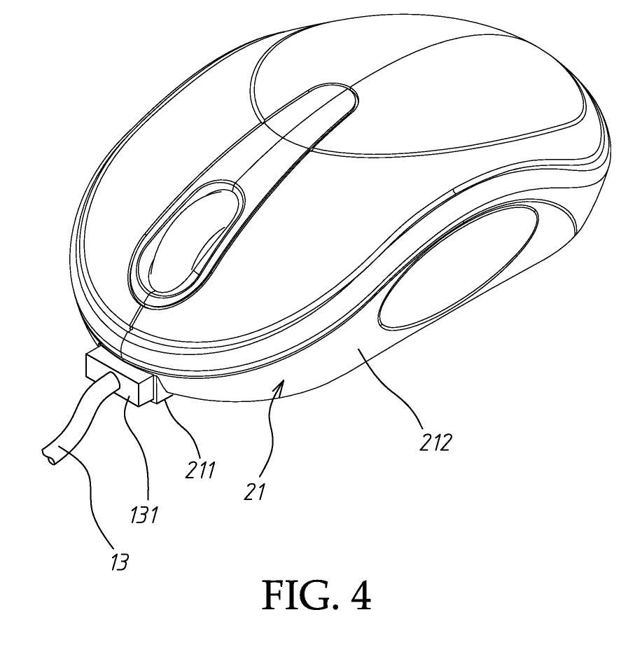

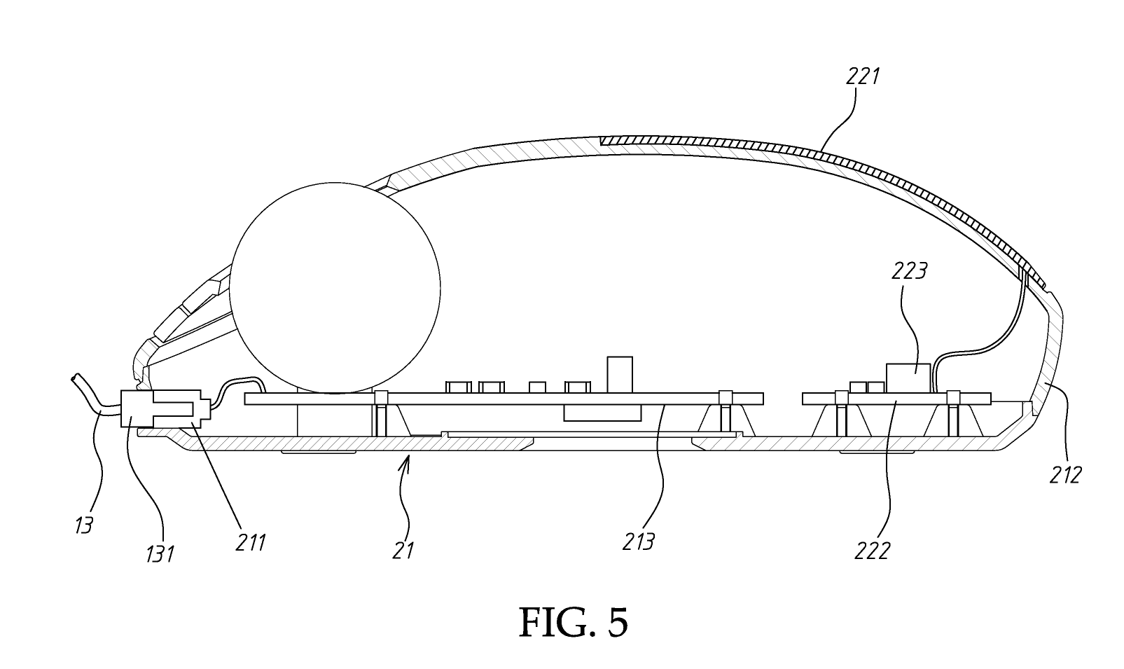

FIGS. 4 and 5 illustrate a mouse warmer in accordance with a second embodiment of the present invention. According to this second embodiment, the mouse warmer comprises a mouse 21 and an electrical heater fixedly installed in the mouse 21.

Similar to the aforesaid first embodiment, the mouse 21 of this second embodiment comprises an electrical jack 211 located on the front side of the housing 212 thereof for the connection of an electrical connector 131 at one end of a USB cable 13, a main circuit board 213 mounted inside the housing 212 and carrying requisite optical components and buttons (not shown) for computer cursor control, as shown in FIG. 5. The electrical heater comprises a sheet-like electrical heating element 221 arranged at the top side of the housing 212 for direct contact of the user's hand holding the mouse 21, a control circuit board 222 mounted inside the housing 212 and electrically connected to the main circuit board 213, and a rechargeable battery cell 125 arranged at the control circuit board 222. Thus, the power supply obtained by the mouse 21 can be used to charge the rechargeable battery cell 223 subject to the control of a charging circuit of the control circuit board 222. The sheet-like electrical heating element 221 is electrically connected to the control circuit board 222, and controllable by the control circuit board 222 to generate heat.

In the aforesaid second embodiment of the present invention, the electrical heater is fixedly mounted in the housing 212 of the mouse 21 for generating heat to warm the user's hand holding the mouse 21. If desired, the user can carry the mouse 21 without the USB cable 13 for body warming when going outside.

Although particular embodiments of the invention have been described in detail for purposes of illustration, various modifications and enhancements may be made without departing from the spirit and scope of the invention. Accordingly, the invention is not to be limited except as by the appended claims.

1. A mouse warmer comprising:
a mouse electrically connectable to a computer for cursor control and having a housing for grasping by a hand of a user; and
an electrical heater having a body shell and generating heat to warm the user's hand holding said housing of said mouse, said body shell of said electrical heater is removably connected to said housing of said mouse.

2. The mouse warmer as claimed in claim 1, wherein said electrical heater is detachably attached to a portion of said housing corresponding to the area to be grasped by a hand of a user.

3. The mouse warmer as claimed in claim 2, wherein said housing of said mouse comprises at least one fastening member located on a top side thereof corresponding to the area to be grasped by a hand of a user; said electrical heater comprises at least one fastening member located on a bottom side of the body shell and detachably connected to the at least one fastening member of said housing of said mouse, and a sheet-like electrical heating element located on a top side of said body shell of said electrical heater.

4. The mouse warmer as claimed in claim 3, wherein said mouse comprises a plurality of metal spring plates located on an exterior of said housing and electrically connected to a power circuit thereof; said electrical heater further comprises a control circuit board mounted inside said body shell of said electrical heater and electrically connected with said sheet-like electrical heating element for controlling the operation of said sheet-like electrical heating element, a rechargeable battery cell electrically connected to said control circuit board and chargeable by a charging circuit of said control circuit board of said electrical heater, a plurality of electric contacts located on a bottom wall of said body shell of said electrical heater and electrically connected to said control circuit board of said electrical heater, said plurality of electric contacts of said body shell of said electrical heater are electrically contacting the metal spring plates at said housing of said mouse for enabling said rechargeable battery cell to be electrically charged by said charging circuit of said control circuit board with a power supply of said mouse.

5. The mouse warmer as claimed in claim 4, wherein said mouse further comprises an electrical jack located on a front side of said housing of said mouse, and a USB cable electrically and detachably connected to said electrical jack for electrically and selectively connecting said mouse to a power source selected from a group consisting of a USB port of a computer and an AC power adapter.

6. The mouse warmer as claimed in claim 4, wherein said body shell of said electrical heater admits light; said electrical heater further comprises an indicator light installed in said control circuit board and controllable by said control circuit board of said electrical heater to emit light through said body shell when said rechargeable battery cell is fully charged during a charging operation, and a charge control switch located on said body shell of said electrical heater and controlling said charging circuit to charge said rechargeable battery cell.

7. The mouse warmer as claimed in claim 4, wherein said electrical heater further comprises a temperature control switch located on said body shell of said electrical heater and controlling the heating temperature of said sheet-like electrical heating element.

8. A mouse warmer comprising:
a mouse electrically connectable to a computer for cursor control and having a housing for grasping by a hand of a user; and
an electrical heater located in said housing and generating heat to warm the user's hand holding said housing;
wherein said electrical heater comprises a sheet-like electrical heating element located on an exterior of a top side of said housing, a control circuit board mounted inside said housing controlling the operation of said sheet-like electrical heating element, and a rechargeable battery electrically connected to said control circuit board and chargeable by a charging circuit of said control circuit board of said electrical heater with a power supply obtained from said mouse.

9. The mouse warmer as claimed in claim 8, wherein said mouse further comprises an electrical jack located on a front side of said housing of said mouse, and a USB cable electrically and detachably connected to said electrical jack for electrically and selectively connecting said mouse to a power source selected from a group consisting of a USB port of a computer and an AC power adapter.
